(19) United States
(12) Patent Application Publication
(10) Pub. No.: US 2011/0248593 A1
(43) Pub. Date: Oct. 13, 2011

(54) Permanent Magnet Rotor for Axial Airgap Motor

(76) Inventor: John Fiorenza, Slinger, WI (US)

(21) Appl. No.: 12/759,135

(22) Filed: Apr. 13, 2010

(51) Int. Cl. H02K 1/28

(52) U.S. Cl. 310/156.29

(57) ABSTRACT

The present invention is a permanent magnet rotor for axial airgap motor apparatus comprised of a rotor frame having a plurality of polarized magnets secured inside retaining bands placed into apertures in the rotor frame. The magnets are arranged so that the polarities of the magnets alternate.

### FIELD OF INVENTION

The present invention relates to the field of axial airgap motors and in particular to a rotor and magnet mounting system.

### BRIEF DESCRIPTION OF THE DRAWINGS

FIG. 1 illustrates a top view of an exemplary embodiment of an axial airgap rotor for an axial airgap flux permanent magnet motor (AFPM motor).

FIG. 2 illustrates an exploded view of an exemplary embodiment of an axial airgap rotor.

FIG. 3a illustrates a perspective view of an exemplary embodiment of a retaining band for an axial airgap rotor.

FIG. 3b illustrates a perspective view of an exemplary embodiment of a retaining band and magnet for an axial airgap rotor.

FIG. 4 illustrates a sectional view of an exemplary embodiment of an axial airgap rotor in use in an axial airgap flux permanent magnet motor (AFPM motor).

### GLOSSARY

As used herein, the term “aerodynamically contoured” means shaped so as to not disrupt air flow.

As used herein, the term “axial airgap flux permanent magnet motor” or “AFPM motor” refers to a motor or generator with a rotor and a stator, in which the magnetic flux between the rotor and the stator is parallel to the axis of rotation of the rotor. Axial flow machines of this type are also known as brushless DC motors, permanent-magnet synchronous motors, disk-armature motors or pancake motors.

As used herein, the term “deformable” means capable of changing shape or form.

As used herein, the term “machining” refers to processes including, but not limited to lathe processes, milling processes, and grinding processes.

As used herein, the term “non-deformable” means not subject to a change in shape or dimensions.

As used herein, the term “polarized” means having positively and negatively charged regions.

As used herein, the term “rotor” refers to the rotational component of a motor which is connected to an output shaft to provide useful work.

As used herein, the term “rotor material” refers to a structural material which is not deformed under high speed rotation (e.g., 500-10,000 rpm). Examples of rotor material include, but are not limited to aluminum, steel alloys, and carbon fiber.

As used herein, the term “stamping” refers to a manufacturing process that uses a stamping tool.

As used herein the term “stator” refers a stationary structure within a motor to which magnetic wire is infused with electric current to move a rotor on which magnets have been mounted.

### BACKGROUND

An axial airgap flux permanent magnet motor (AFPM motor) includes a stator and a rotor. The stator is a stationary structure to which wire is mounted and through which electrical current flows. The rotor has permanent magnets which are arranged in a circular manner around the shaft, at alternating polarities.

Examples of AFPM motors are known in the art. U.S. Pat. No. 5,619,087 (Sakai '087) teachers the use of two ironless disk-shaped rotors with relatively small, bar-shaped permanent magnets, which are embedded in a fiber or fiber-reinforced plastic. The magnets are arranged next to one another respectively to form a group, which forms one magnetic pole. However, the rotor taught by Sakai '087 is not desirable because it uses two rotors and adhesive to secure the magnets. In addition, anchoring the magnets in plastic presents problems in terms of production and strength.

Another example of a rotor for use in an AFPM motor is taught by U.S. Pat. No. 6,674,214 (Knörzer '214). Knörzer '214 teaches an electric axial flow machine with an ironless disk-shaped rotor which is arranged on a machine shaft. The rotor has permanent magnets, which are embedded in a fiber or fabric-reinforced plastic, eliminating the need for two rotors or adhesive.

Permanent magnets are arranged in a circular manner around the machine shaft and the plastic (e.g., a thermosetting material) extends between the magnets. The rigid permanent magnets serve as stiffening elements and their positive connection with the surrounding plastic ensures that the magnets do not become detached.

The rotor taught by Knörzer '214, however, has several limitations. First, the magnets must be individually charged after molding, making the devices very expensive to produce. The process to produce the rotor must be performed at high temperatures, which demagnetize the magnets requiring that the magnets be charged after molding.

A second drawback is that the plastic is subject to deformation from the heat of the motor during use. For example, the rotor has limited performance at rotational speeds over 5000 rpm which will cause the material to start to deform.

It is desirable to have a non-deformable rotor which can withstand high temperatures and high rpm.

It is further desirable to have a rotor which can be manufactured using pre-charged magnets.

It is further desirable to have a rotor which is lightweight and commercially advantageous to manufacture, and which does not require the use of adhesives for securing magnets at high speeds.

### SUMMARY OF THE INVENTION

The present invention is a permanent magnet rotor for an axial airgap motor apparatus comprised of a rotor frame having a plurality of apertures for receiving a polarized magnet and a retaining band. Magnets are polarized and secured inside retaining bands. The retaining bands and magnets are inserted into the apertures in the rotor frame so that the polarities of the magnets are alternating. The rotor frame also includes a center aperture for placing on a shaft and apertures for securing the rotor frame to the shaft.

### DETAILED DESCRIPTION OF INVENTION

For the purpose of promoting an understanding of the present invention, references are made in the text to exemplary embodiments of an axial airgap rotor with permanent magnets for an axial airgap motor, only some of which are described herein. It should be understood that no limitations on the scope of the invention are intended by describing these exemplary embodiments. One of ordinary skill in the art will readily appreciate that alternate but functionally equivalent materials, designs and configurations may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

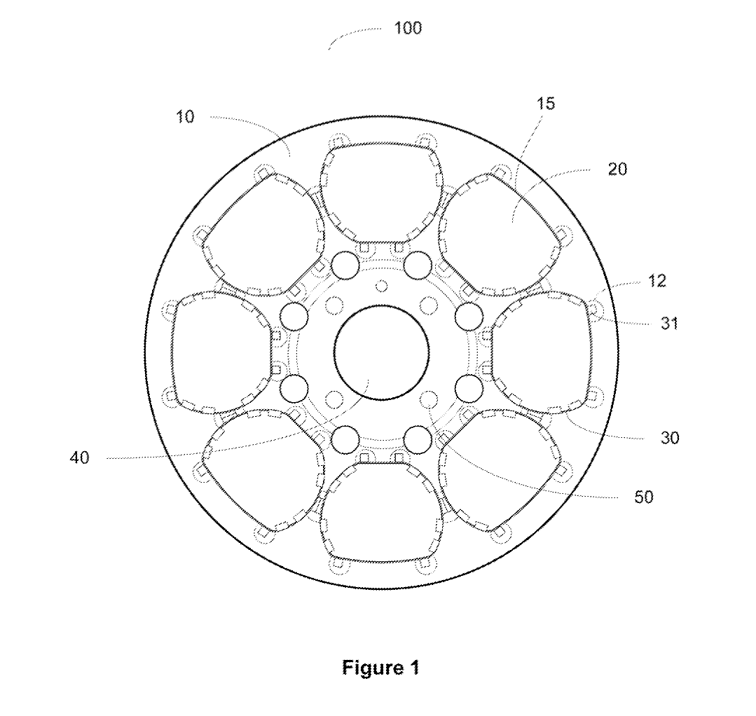

FIG. 1 illustrates a top view of an exemplary embodiment of AFPM motor rotor 100 comprised of rotor frame 10 having magnet apertures 15, shaft aperture 40, and securing apertures 50. Magnets apertures 15 are adapted to receive a plurality of retaining bands 30 and a plurality of magnets 20 (not all of which have been individually labeled on the drawing).

Retaining bands 30 are used to stabilize magnets 20 inside magnet apertures 15. Retaining bands 30 accounting for variations in size and tolerance of magnets 20. For example, as a result of manufacturing, the length of the magnets can vary by as much as 0.002 inches. Retaining bands 30 bend to accommodate varying shapes and sizes of magnets 20 or magnets having beveled edges.

In the embodiment shown, rotor frame 10 is adapted to accommodate eight magnets 20. In the embodiment shown, magnets 20 are semi-elliptical shaped and have two flattened sides and flattened top and bottom surfaces. The semi-elliptical shape of magnets 20 provides a sinusoidal generated voltage, that is, a smooth electrical wave, reducing motor noise. However, in other embodiments, magnets 20 may be another shape including, but not limited to circular, square, triangular, oval, polygonal, and irregular shaped.

In the embodiment shown, rotor frame 10 and retaining bands 30 are comprised of aluminum; however, in other embodiments may be comprised of other materials including, but not limited to steel alloys, non-magnetic stainless steel, carbon fiber or any other material that does not deform at high rpm.

In the embodiment shown, magnets 20 are neodymium iron boron magnets; however, in other embodiments, magnets 20 may be comprised of another material including, but not limited to iron, nickel, cobalt, ferrite, alnico, ticonal and lodestone.

In the embodiment shown, magnets 20 are charged and placed in rotor frame 10 so that the visible surfaces of magnets 20 have alternating polarities.

In other embodiments, rotor frame 10 is designed to accommodate more or fewer magnets, magnets of varying sizes, or magnets with deliberate size variations.

In the embodiment shown, rotor frame 10 further includes surface contours 12 for receiving retaining band tabs 31.

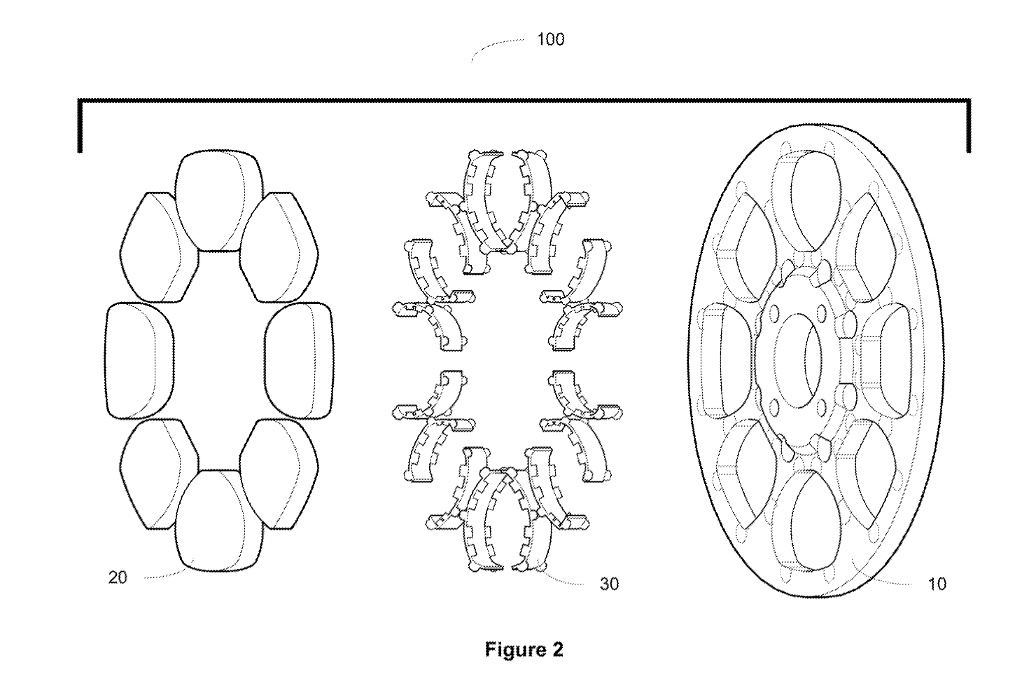

FIG. 2 illustrates an exploded view of an exemplary embodiment of AFPM motor rotor 100.

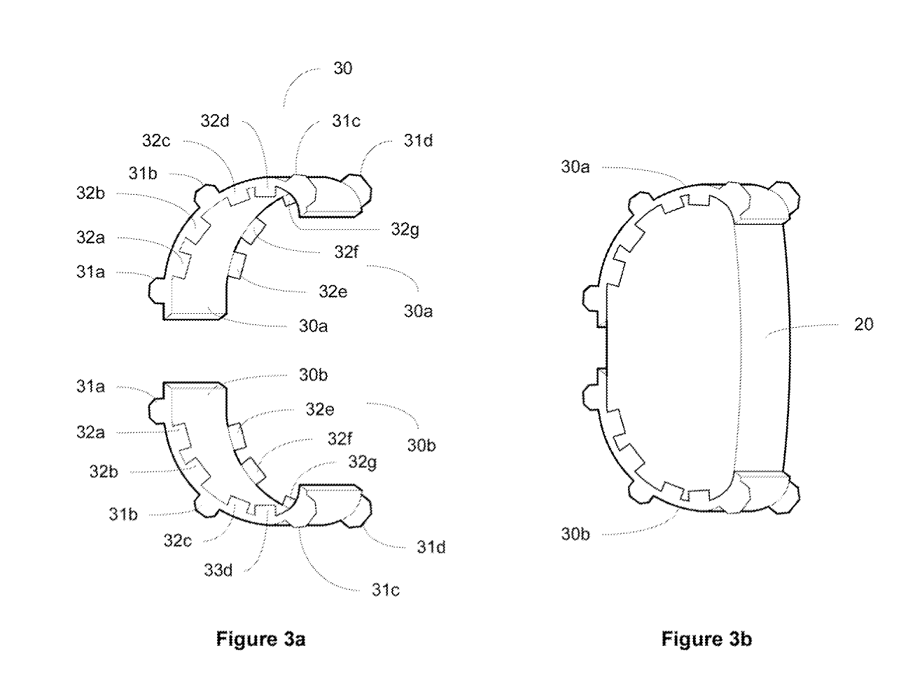

FIG. 3a illustrates a perspective view of an exemplary embodiment of retaining band 30 for securing magnet 20 (not shown). In the embodiment shown, retaining band 30 is comprised of two halves 30a, 30b. Each halve of retaining band 30 has retaining band tabs 31a-31d and securing tabs 32a-32g. Retaining band tabs 31a-31d rest in surface contours 12 of rotor frame 10 (not shown) and securing tabs 32a-32g secure magnet 20 inside retaining band 30.

In other embodiments, retaining band 30 may be comprised of more or fewer pieces and may have more or fewer retaining band tabs 31 and/or securing tabs 32 or have tabs 31, 32 of varying shapes.

FIG. 3b illustrates a perspective view of an exemplary embodiment of retaining band halves 30a, 30b secured around magnet 20.

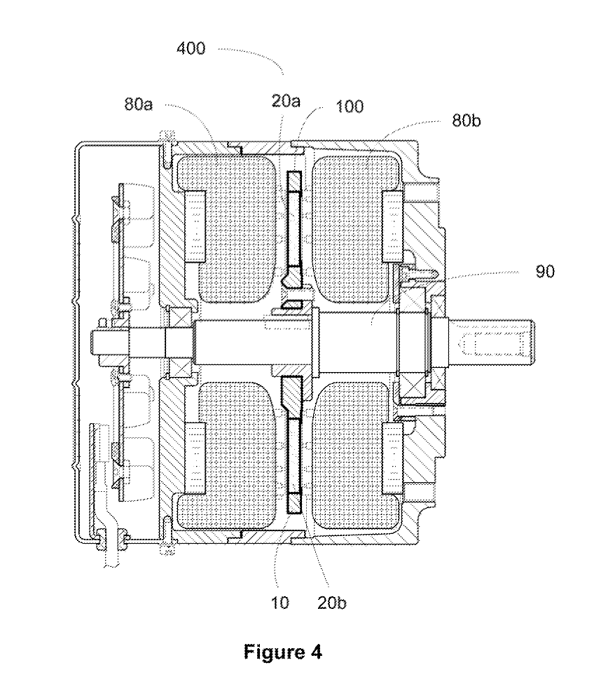

FIG. 4 illustrates a sectional view of an exemplary embodiment of an AFPM motor 400 with AFPM rotor 100. Visible are rotor frame 10, magnets 20a, 20b, stators 80a, 80b and shaft 90.

Coils of wire (not visible) are located between AFPM rotor 100 and stators 80a, 80b. Power is supplied to the coils creating an alternating electric current, which in turn creates a magnetic field that is designed to turn the rotor by magnetic attraction.

What is claimed is:

1. A rotor for an axial airgap motor apparatus comprised of:
at least one non-deformable metal rotor frame having a plurality of apertures, each of said plurality of apertures adapted to receive a polarized permanent magnet and a retaining band to secure said polarized permanent magnet without the use of adhesive;
a plurality of pre-polarized permanent magnets;
a plurality of retaining bands; and
a center aperture.

2. The apparatus of claim 1 wherein said at least one metal rotor frame is capable of withstanding temperatures of 400° F.

3. The apparatus of claim 1 wherein each of said plurality of apertures has a semi-elliptical shape.

4. The apparatus of claim 3 wherein each of said plurality of pre-polarized permanent magnets has a semi-elliptical shape.

5. The apparatus of claim 1 wherein each of said plurality of retaining bands has at least one deformable retaining band tab.

6. The apparatus of claim 5 wherein said rotor frame further includes at least one surface contour adapted to receive said at least one deformable retaining band tab.

7. The apparatus of claim 1 wherein said plurality of polarized magnets are aerodynamically contoured.

8. The apparatus of claim 1 wherein said at least one rotor frame and said plurality of retaining bands are comprised of materials selected from a group consisting of aluminum, steel alloys, non-magnetic stainless steel and carbon fiber.

9. The apparatus of claim 1 which includes eight pre-polarized permanent magnets.

10. The apparatus of claim 1 wherein said plurality of retaining bands hold said plurality of pre-polarized permanent magnets in place with pressure.

11. The apparatus of claim 1 wherein said plurality of retaining bands further include at least one deformable securing tab for securing one of said plurality of pre-polarized permanent magnets.

12. A rotor for an axial airgap motor apparatus comprised of:
at least one rotor frame having a plurality of apertures adapted to receive a plurality of semi-elliptical magnets; and
a plurality of semi-elliptical magnets.

13. The apparatus of claim 12 which further includes a plurality of retaining bands having at least one deformable retaining band tab and at least one deformable securing tab for securing one of said plurality of semi-elliptical magnets.

14. The apparatus of claim 13 wherein said at least one rotor frame, said plurality of semi-elliptical magnets, and said plurality of retaining bands are aerodynamically contoured.

15. The apparatus of claim 14 wherein said at least one rotor frame, said plurality of semi-elliptical magnets, and said plurality of retaining bands have surfaces that are flat and even.

16. A method of making a permanent magnet rotor for an axial airgap motor apparatus comprised of the steps of:
machining a rotor frame having a plurality of apertures and surface contours;
tooling a plurality of retaining bands having a plurality of retaining band tabs and a plurality of securing tabs;
inserting a pre-polarized magnet in each of said plurality of retaining bands; and
inserting each of said plurality of retaining bands with said pre-polarized magnet in one of said plurality of apertures in said rotor frame.

17. The method of claim 16 which further includes the step of bending said plurality of retaining band tabs outward and said plurality of securing tabs inward.

18. The method of claim 17 wherein said plurality of retaining bands are inserted into said plurality of apertures so that said retaining band tabs rest in said surface contours.
